(19) United States
(12) Patent Application Publication
(10) Pub. No.: US 2022/0008872 A1
(43) Pub. Date: Jan. 13, 2022

(54) Aeration Container

(71) Applicant: MKB VENTURES, INC., PACIFIC PALISADES, CA (US)

(72) Inventor: Kevin D. McGushion, Simi Valley, CA (US)

(21) Appl. No.: 17/373,652

(22) Filed: Jul. 12, 2021

Related U.S. Application Data
(60) Provisional application No. 63/050,714, filed on Jul. 10, 2020.

(51) Int. Cl. B01F 3/04

(52) U.S. Cl. CPC B01F 3/04794; B01F 2215/0072; B01F 3/04829

(57) ABSTRACT

The present specification discloses an aeration container that automatically aerates wines and other beverages simultaneously while being poured or directly consumed from the aeration container. The aeration container includes an aeration plate that divides the beverage into multiple streams to maximize surface area in contact with the surrounding air. Further, a dispensing nozzle is provided with a converging dispensing passage with air syphon holes formed transversely into the passage to permit air to be syphoned into the converging dispensing passage for further aeration of the beverage flowing therethrough. The present aeration container permits immediate enjoyment of an aerated beverage without the increased wait time and extra step of existing methods.

This patent application claims the benefit of U.S. Provisional Patent Application Ser. No. 63/050,714, entitled “Aeration Container,” filed Jul. 10, 2020, which application is incorporated in its entirety here by this reference.

### BACKGROUND

The subject of this patent application relates generally to aeration devices, and more particularly to aeration containers and/or aeration components for introducing oxygen into a fluid contained therein, such as wine, whiskey, and the like.

By way of background, wine and other beverages are aerated such that oxygen containing air is brought into contact with the beverage. The oxygen reacts with components of the beverage to produce a desired favor or other desirable attributes. For example, young wines are aerated, to reduce the bitterness caused by tannins, by oxidizing and evaporating these undesirables naturally occurring polyphenols. One of the primary methods of aerating wine is to pour the wine into a decanter to maximize liquid surface to air contact. Other methods include swirling the wine within a wine glass, pouring the wine back and forth between two containers, and even mixing the wine within a blender. These methods take time and require separate processes and/or separate equipment to achieve.

Aspects of the present invention fulfill these needs and provide further related advantages as described in the following summary.

### SUMMARY

Aspects of the present invention teach certain benefits in construction and use which give rise to the exemplary advantages described below.

The present specification discloses an aeration container for containing a beverage, comprising a beverage reservoir with an aerating nozzle. The beverage reservoir is generally delineated by a sidewall, a bottom wall, and a top wall opposite the bottom wall, and is configured to hold the beverage therein. The aerating nozzle includes a dispensing passage formed therethrough with a reduced diameter portion of the dispensing passage, and an air syphon hole formed transverse to the dispensing passage communicating between the reduced diameter portion of the dispensing passage and atmosphere. The aerating nozzle extends from the top wall, such that the dispensing passage provides fluid communication between the beverage reservoir and atmosphere through the dispensing passage. When tilted for dispensing, air is drawn into the dispensing passage through the air syphon hole to interact with the beverage flowing through the dispensing passage.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present aeration container. In such drawings:

FIG. 1 is an assembled top perspective view of the present aeration container, in accordance with at least one embodiment disclosed herein;

FIG. 2 is an exploded top perspective view of the aeration container of FIG. 1;

FIG. 3 is an assembled top view of the aeration container of FIG. 1;

FIG. 4 is an assembled side view of the aeration container of FIG. 3;

FIG. 5 is an assembled cross-sectional side view of the aeration container of FIG. 3, taken along 5-5;

FIG. 6 is an assembled cross-sectional perspective view of the aeration container of FIG. 5, illustrating the dispensing of a fluid;

FIG. 7 is a magnified cross-sectional side view of the aeration container cover of FIG. 6, illustrating the movement and interaction of air and liquid;

FIG. 8 is a top perspective view of the dispensing nozzle;

FIG. 9 is a top view of the dispensing nozzle of FIG. 8;

FIG. 10 is side view of the dispensing nozzle of FIG. 8; and

FIG. 11 is cross-sectional view of the dispensing nozzle of FIG. 8, taken along 11-11.

The above-described drawing figures illustrate aspects of the present aeration container in at least one of its exemplary embodiments, which are further defined in detail in the following description. Features, elements, and aspects of the aeration container and components that are referenced by the same numerals in different figures represent the same, equivalent, or similar features, elements, or aspects, in accordance with one or more embodiments.

### DETAILED DESCRIPTION

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

The present specification discloses an aeration container that automatically aerates wines and other beverages simultaneously while being poured or directly consumed from the aeration container. The aeration container includes an aeration plate that divides the beverage into multiple streams to maximize surface area in contact with the surrounding air. Further, a dispensing nozzle is provided with a converging dispensing passage with air syphon holes formed transversely into the passage to permit air to be syphoned into the converging dispensing passage for further aeration of the beverage flowing therethrough. The present aeration container permits immediate enjoyment of an aerated beverage without the increased wait time and extra step of existing methods.

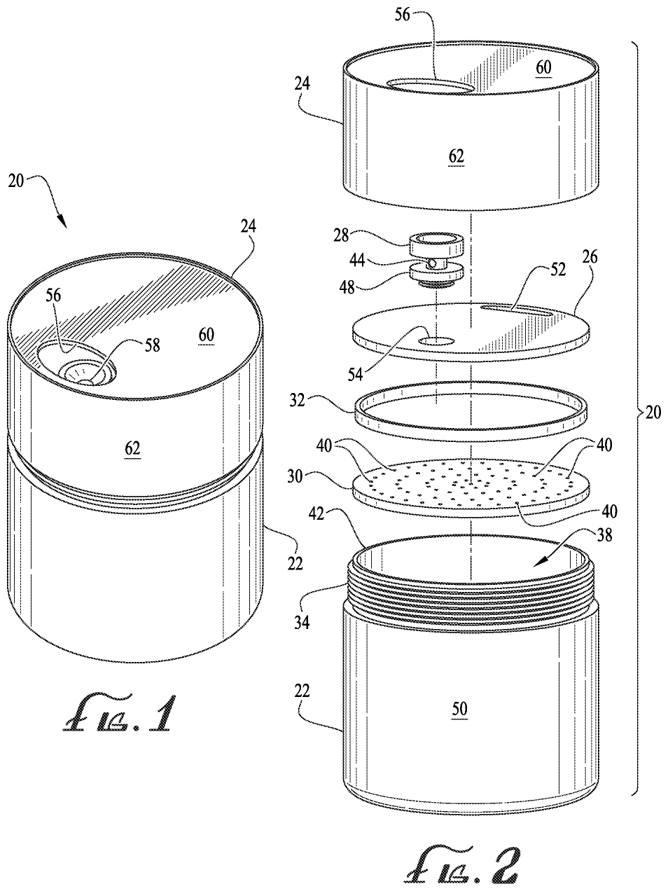

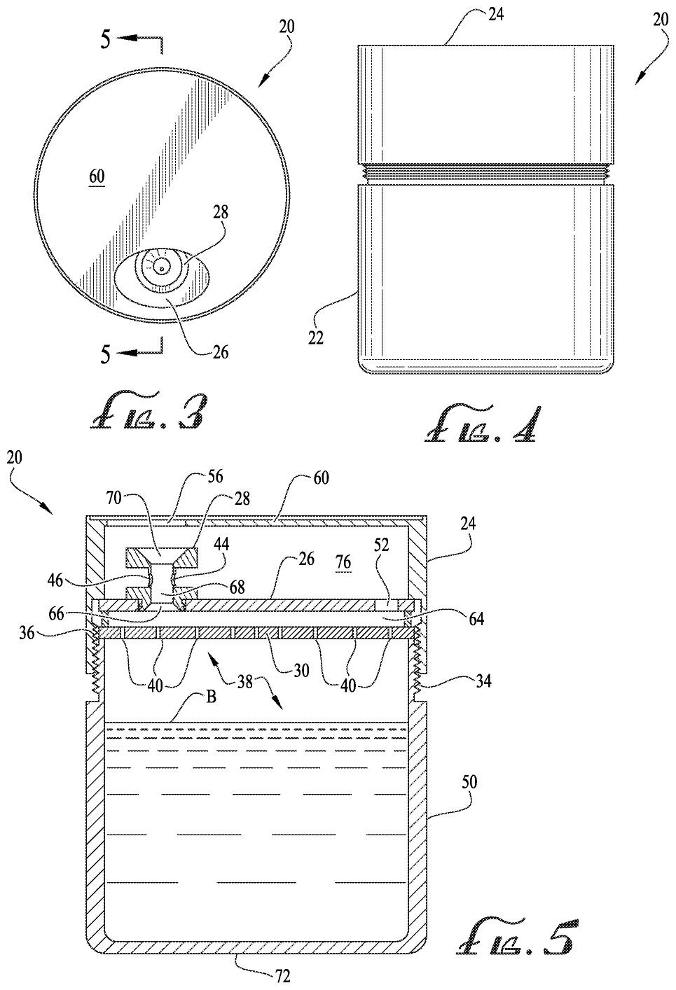

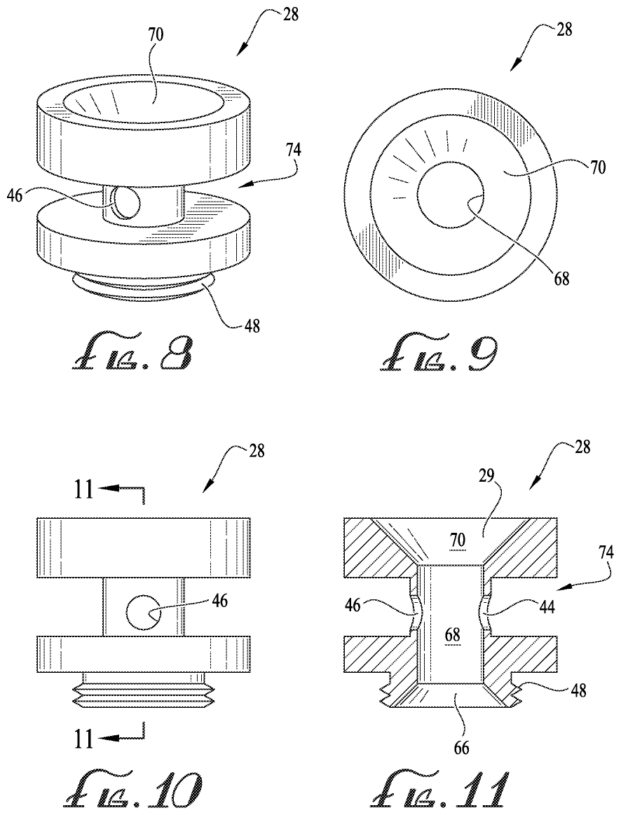

Referring first to FIGS. 1-11, an example embodiment of the present aeration container 20 is illustrated, and generally includes a beverage reservoir 22, a top wall 26 configured to close the beverage reservoir 22, and a dispensing nozzle 28 for pouring a beverage B contained within the beverage reservoir 22 therethrough while simultaneously aerating the beverage B. Optionally, the aeration container 20 can include an aeration plate 30 positioned beneath and spaced apart from the top wall 26 by a spacer ring 32 inserted therebetween. The beverage reservoir 22 can be delineated in one or more embodiments by the side wall 50, the bottom wall 72, and the top wall 26. Alternatively, the beverage reservoir 22 can be delineated in one or more embodiments by the side wall 50, the spacer ring 32 extending upward from the side wall 50, the bottom wall 72, and the top wall 26.

Looking more closely at the beverage reservoir 22, in one or more embodiments, it includes a side wall 50 (cylindrical in this example, like a can) and a bottom wall 72, which together define an interior space 38 into which a beverage can be deposited in a standard canning process (in the example of an aluminum can) or be filled at home or other point of consumption through the opening defined by the rim 42. A first thread 34 (a male thread formed on the outer diameter of the side wall 50 in this example) is formed adjacent to the rim 42, and is configured to receive the second thread 36 of the container lid 24.

The container lid 24 includes a lid side wall 62 and a lid top wall 60. The second thread 36 (a female thread formed on the inner diameter of the lid side wall 62 in this example) is configured to be threaded upon the first thread 34 to selectively attach the lid 24 to the beverage reservoir 22. The lid top wall 60 includes a pour-through opening 56, which permits a beverage B to be poured therefrom.

The top wall 26 in sized to cover and enclose the interior space 38 and includes an air inlet hole 52 and a threaded hole 54. The threaded hole 54 is configured to receive the nozzle thread 48 of the dispensing nozzle 28. The dispensing nozzle 28 includes a dispensing passage 29 formed along the axis about which the nozzle thread 48 is formed. The dispensing passage 29 generally converges to a reduced diameter portion 68, converging from the nozzle thread 48 towards the reduced diameter portion 68. A first air syphon hole 44 and an optional second air syphon hole 46 are drilled laterally to intersect the dispensing passage 29, preferably at the reduced diameter portion 68, to provide fluid communication between atmosphere and the dispensing passage 29. The first air syphon hole 44 and the second air syphon hole 46 are each sized and configured to permit the drawing in of air from atmosphere to the dispensing passage 29, due to the syphon effect of the beverage B flowing through the reduced diameter portion 68 of the dispensing passage 29 at velocity. Optionally, the dispensing passage 29 diverges from the reduced diameter portion 68 towards the outlet of the dispensing passage 29. In one or more embodiments, the dispensing passage 29 can converge continuously from the inlet to the outlet. In one or more embodiments, the dispensing passage 29 can converge from the inlet to the reduced diameter portion 68, then the diameter of the reduced diameter portion 68 remains continuous to the outlet. In one or more embodiments, the reduced diameter portion 68 can be a point selected on the embodiment with dispensing passage 29 converging continuously from the inlet to the outlet, where the reduced diameter portion 68 may or may not be the point of smallest diameter. Although the top wall 26 and the dispensing nozzle 28 are illustrated herein as being two nondestructively separable parts (i.e., the two parts can be separated and reattached without permanent damage to the parts), they can be stamped from the same part, such as from a thin aluminum sheet.

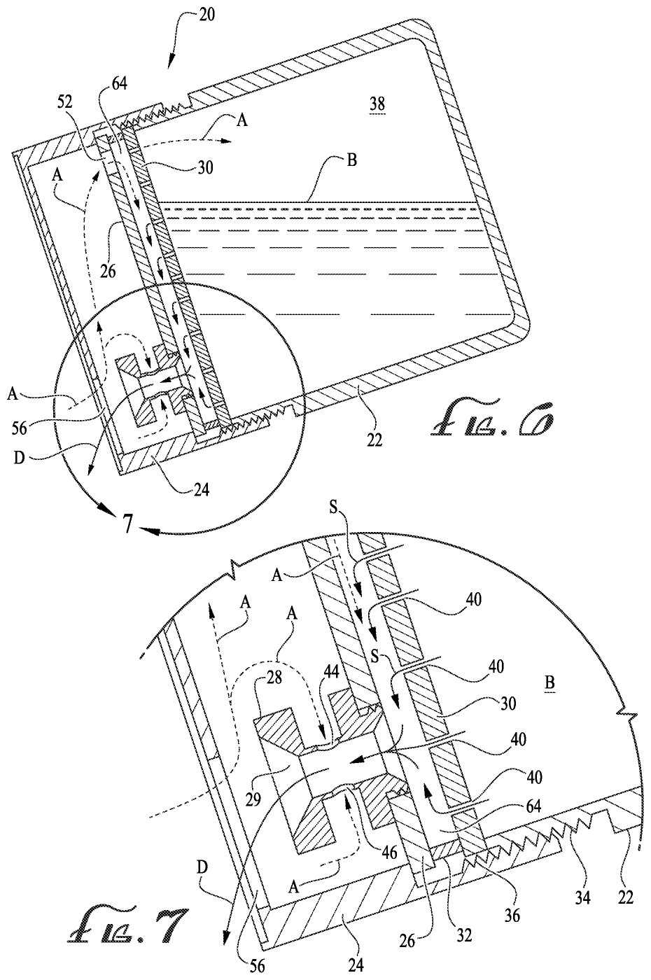

In one or more embodiments, the optional aeration plate 30 is positioned on the rim 42 of the beverage reservoir 22, beneath the top wall 26 and with a spacer ring 32 sandwiched between the top wall 26 and the aeration plate 30 to delineate an aeration chamber 64 as part of the beverage reservoir 22. In the illustrated embodiment, the aeration plate 30 rests upon the rim 42, with the spacer ring 32, in turn, resting upon the aeration plate 30, where the spacer ring 32 enclosing one or more aeration holes 40 formed through the aeration plate 30 (e.g., a plurality or a multiplicity of aeration holes 40 are drilled, stamped, etc. therethrough). Although the top wall 26, the spacer ring 32, and the aeration plate 30 are illustrated herein as being nondestructively separable parts, the spacer ring 32 can be eliminated with the top wall 26 and the aeration plate 30 being stamped from aluminum sheets (or the like) to form the described features and the desired spacing, with their outer edges rolled together and to rim 42 of the beverage reservoir 22 using known canning techniques. Thus, the present aeration container 20 can be made to be permanently sealed together (i.e., the parts cannot be separated without causing permanent damage to the parts and/or the seal between the parts). Although the lid 24 is illustrated in the example embodiment of FIGS. 6-7, it is optional, and the remaining portions of aeration container 20 can operate as described. The lid 24 serves to enclose and protect from damage and contamination the dispensing nozzle 28 and other exposed parts, as well as directing the flow of the air A.

Looking particularly at FIGS. 6-7, the example embodiment of the aeration container 20 is shown tilted for dispensing or decanting the beverage B therefrom. It can be seen in the illustrations that the aeration container 20 is tilted such that the dispensing nozzle 28 is generally oriented to a position that permits the beverage B to flow through the dispensing passage 29. In one or more embodiments, when the aeration container 20 is tilted the dispensing nozzle 28 is generally oriented to lowest position (or thereabouts) and the air inlet hole is positioned oppositely to the dispensing nozzle 28 and in the highest position (or thereabouts). In this way, air A is permitted to flow into the interior space 38 of the beverage reservoir 22, entering the aeration container 20 from the pour-through hole 56 of the lid 24 (or other air inlet) and through the air inlet hole 52 of the top wall 26, and optionally into the interior space 38 of the beverage reservoir 22 through the uppermost aeration holes 40 of the aeration plate 30 (the holes 40 from which streams S of the beverage B are not issuing).

The process of aeration occurs simultaneously while pouring the beverage B and as part of the process of pouring (i.e., the aeration itself occurs automatically and with little or no intervention by the user in a normal pouring process). In one example method, the user tilts the aeration container 20, as described above. As the dispensed beverage D issues from the outlet of the dispensing nozzle 28 and into a glass (for consumption or a decanter for later consumption), air A is sucked into the pour-through hole 56, pulled in by the exiting beverage B. The air A enters the aeration chamber 64 of the beverage reservoir 22 through the air inlet hole 52 of the top plate 26. A portion of the air A stream flows between the top wall 26 and the aeration plate 30 within the aeration chamber 64. And a portion of the air A stream flows through the aeration holes 40 and into the interior space 38 of the beverage reservoir 22 to fill the void of the exiting beverage B and to interact and aerate the beverage B contained within the interior space 38. Further a portion of the air A entering the pour-through hole 56 is directed to the first air syphon hole 44 and the second air syphon hole 46 of the dispensing nozzle 28 within the lid 24 interior space.

Looking first at the air A flow within the aeration chamber 64, the air enters the aeration chamber 64 through the air inlet hole 52 as the beverage B flows through the aeration holes 40 also enter the aeration chamber 64 in a first stage of aeration. The multiplicity of aeration holes 40 divides the beverage into a multiplicity (or one or more) small beverage streams S with an aeration space surrounding each stream, where the size the of the aeration space is determined by the spacing of the aeration holes 40. Because the beverage is divided into small beverage streams S with the aeration space provides thereabout each stream S, the air A can easily flow between the beverage streams S within the aeration spaces. In this way, many, if not all, of the beverage streams S can be surrounded by air A so that each of the beverage streams S is individually aerated. Basically, the aeration holes 40 in the aeration plate 30 increases the surface area of the beverage B exposed to air A, increasing the rate of aeration of the beverage B (i.e., decreasing the amount of time required to aerate a give quantity of beverage B).

The aeration holes 40 can be evenly or unevenly distributed about the aeration plate 30 (in a pattern or randomly), or can be just formed in select regions. The position and size of the aeration holes 40 can also be determined using mathematical modeling and/or experimentation to determine the most efficient spacing of the holes 40 for each given portion of the aeration plate 30. For example, it might be determined that the beverage streams nearest the top of the beverage B level have a slower relative flow rate through the holes 40 which may permit smaller relative spacing and/or larger relative hole 40 sizing compared to holes 40 found nearer to the bottom of the beverage B level during pouring. Further, the hole 40 pattern can be adjusted to permit passages for more efficient air A flow about all the beverage streams S. In at least one embodiment, area of each of the aeration holes 40 are relatively small compared to the total area of the aerator plate 30. For example, the area of each of the aeration holes 40 is less than 1/10 the area of the aerator plate 30 area, or less than 1/20 the area of the aerator plate 30 area, or less than 1/50 the area of the aerator plate 30 area, or less than 1/100 the area of the aerator plate 30 area.

A second stage of aeration occurs within the dispensing nozzle 28. The beverage B enters the dispensing passage 29 of the dispensing nozzle 28 through the converging inlet 66 (see FIGS. 8-11), where the converging inlet increases the flow velocity of the beverage B, thus decreasing its pressure at the reduced diameter portion 68. Because the beverage B flowing through the reduced diameter portion 68 has a pressure that is lower relative to atmosphere, a syphon is created at the first air syphon hole 44 and the second air syphon hole 46, which pulls air A into the syphon holes 44, 46 and into the dispensing passage 29. The air A enters the dispensing passage 29 and immediately mixes with the beverage B flowing within the passage 29, thus aerating the beverage B a second time as the beverage is being dispensed. Optionally, a diverging outlet 70 can be provided to permit expansion of the beverage B stream to permit enhanced mixing between the air A and the beverage B. The dispensed aerated beverage D issues from the dispensing nozzle 28 and exits the lid 24 through the pour-through hole 56, ready for consumption.

FIGS. 8-11 illustrate one example embodiment of the dispensing nozzle 28 in a several views. The mains body of the dispensing nozzle 28 is cylindrical with an optional annular groove 74 formed about the body, with the syphon holes 44, 46 drilled into the body at the bottom of the annular groove 74. The syphon holes 44, 46 provide air A fluid communication between atmosphere and the beverage B flowing within the dispensing passage 29. The one or more syphon holes 44, 46 are formed at the reduced diameter portion 68, which is the point of highest beverage B velocity and lowest pressure, providing the best syphon effect. However, other positions of the syphon holes 44, 46 may be selected based on syphon or other design considerations.

In one or more embodiments, the dispensing passage 29 comprises a converging inlet 66 transitioning to a reduced diameter portion 68, which optionally transitions to a diverging outlet 70 in a venturi or venturi-like form. Further, a thread 48 is optionally provided to threadably engage the threaded hole 54 of the top wall 26.

Although the dispensing nozzle 28 is illustrated and described as being connected with the disclosed containers (both reusable containers and disposable containers), in one or more embodiments, the present dispensing nozzle 28 does not require a specific container (such as the containers described) and is operable in itself. Thus, the dispensing nozzle 28 by itself, or a dispensing nozzle 28 and top wall 26 assembly, or a dispensing nozzle 28, aeration plate 30, and top wall 26 assembly can be manufactured and sold as attachments to numerous container designs, for aerating or mixing in a fluid (such as a gas or other fluid) in beverages, or even for other non-consumable liquids where it is a desire to introduce a fluid.

The present aeration container 20 advantageously provides a quick and easy means to simultaneously pour and aerate a beverage B for immediate consumption. The aeration container 20 can pour the aerated beverage B into a glass, a decanter or other container, or can be directly consumed through the pour-through hole 56 (where a separate air inlet can be provided through the lid top wall 60 is required). The present aeration container 20 permits immediate enjoyment of an aerated beverage B without the increased wait time and extra step of prior methods.

Aspects of the present specification may also be described as follows:

1. An aeration container for containing a beverage, comprising a beverage reservoir delineated by a sidewall, a bottom wall, and a top wall opposite the bottom wall, the beverage reservoir being configured to hold the beverage therein, the top wall including an air inlet hole; an aerating nozzle having a dispensing passage formed therethrough with a reduced diameter portion of the dispensing passage, and an air syphon hole formed transverse to the dispensing passage communicating between the reduced diameter portion of the dispensing passage and atmosphere, the aerating nozzle extending from the top wall such that the dispensing passage provides fluid communication between the beverage reservoir and atmosphere through the dispensing passage; and an aeration plate having a multiplicity of holes formed therethrough and being positioned within the beverage reservoir spaced apart from and beneath the top wall to delineate an aeration chamber within the beverage reservoir; wherein, when tilted for dispensing, air is drawn into the beverage reservoir through the air inlet hole of the top plate to interact with the beverage flowing through at least some of the multiplicity of holes issuing in a plurality of beverage streams; and wherein, when tilted for dispensing, air is drawn into the dispensing passage through the air syphon hole to interact with the beverage flowing through the dispensing passage.
2. The aeration container of embodiment 1, wherein the dispensing passage of the aerating nozzle further comprises a converging inlet upstream of the reduced diameter portion.
3. The aeration container of embodiments 1 or 2, wherein the dispensing passage of the aerating nozzle further comprises a diverging outlet downstream of the reduced diameter portion.
4. The aeration container of any one of embodiments 1-3, wherein a container lid configured to cover the top wall and substantially enclose the aerating nozzle, the container lid having a pour through opening configured to be aligned with the aerating nozzle such that the beverage issuing from the dispensing passage flows through the pour through opening.
5. The aeration container of any one of embodiments 1-4, wherein the pour through opening is sufficiently large to permit simultaneous outflow of the beverage and inflow of the air traveling to the air inlet hole and the air syphon hole.
6. The aeration container of any one of embodiments 1-5, wherein the aeration plate is spaced apart from the top wall by a spacer ring further delineating and enclosing the aeration chamber, the side wall includes a first thread and the container lid includes a second thread configured to engage the first thread and hold the spacer ring between the top wall and the aeration plate.
7. The aeration container of any one of embodiments 1-6, wherein the beverage reservoir, the aerating nozzle, and the aeration plate are nondestructively separable from one another.
8. An aeration container for containing a beverage, comprising a beverage reservoir delineated by a sidewall, a bottom wall, and a top wall opposite the bottom wall, the beverage reservoir being configured to hold the beverage therein; and an aerating nozzle having a dispensing passage formed therethrough with a reduced diameter portion of the dispensing passage, and an air syphon hole formed transverse to the dispensing passage communicating between the reduced diameter portion of the dispensing passage and atmosphere, the aerating nozzle extending from the top wall such that the dispensing passage provides fluid communication between the beverage reservoir and atmosphere through the dispensing passage; wherein, when tilted for dispensing, air is drawn into the dispensing passage through the air syphon hole to interact with the beverage flowing through the dispensing passage.
9. The aeration container of embodiment 8, further comprising an aeration plate having a multiplicity of holes formed therethrough and being positioned within the beverage reservoir spaced apart from and beneath the top wall to delineate an aeration chamber within the beverage reservoir.
10. The aeration container of embodiments 8 or 9, wherein when tilted for dispensing, air interacts with the beverage flowing through at least some of the multiplicity of holes issuing in a plurality of beverage streams within the aeration chamber.
11. The aeration container of any one of embodiments 8-10, wherein the top wall further includes an air inlet hole, wherein, when tilted for dispensing, air is drawn into the beverage reservoir through the air inlet hole of the top plate to interact with the beverage flowing through at least some of the multiplicity of holes issuing in a plurality of beverage streams within the aeration chamber.
12. The aeration container of any one of embodiments 8-11, wherein the dispensing passage of the aerating nozzle further comprises a converging inlet upstream of the reduced diameter portion.
13. The aeration container of any one of embodiments 8-12, wherein the dispensing passage of the aerating nozzle further comprises a diverging outlet downstream of the reduced diameter portion.
14. The aeration container of any one of embodiments 8-13, further comprising a container lid configured to cover the top wall and substantially enclose the aerating nozzle, the container lid having a pour through opening configured to be aligned with the aerating nozzle such that the beverage issuing from the dispensing passage flows through the pour through opening.
15. The aeration container of any one of embodiments 8-14, wherein the pour through opening is sufficiently large to permit simultaneous outflow of the beverage and inflow of the air traveling to the air inlet hole and the air syphon hole.
16. The aeration container of any one of embodiments 8-15, wherein the aeration plate is spaced apart from the top wall by a spacer ring further delineating and enclosing the aeration chamber, the side wall includes a first thread and the container lid includes a second thread configured to engage the first thread and hold the spacer ring between the top wall and the aeration plate.
17. The aeration container of any one of embodiments 8-16, wherein the beverage reservoir, the aerating nozzle, and the aeration plate are nondestructively separable from one another.
18. A method of aerating a beverage comprising providing an aeration container having a beverage reservoir containing the beverage therewithin, and with an aerating nozzle extending from a top wall of the aeration container, the aerating nozzle having a dispensing passage formed therethrough with a reduced diameter portion of the dispensing passage, and an air syphon hole formed transverse to the dispensing passage communicating between the reduced diameter portion of the dispensing passage and atmosphere, the dispensing passage provides fluid communication between the beverage reservoir and atmosphere through the dispensing passage; tilting the aeration container such that the beverage issues from the dispensing passage of the aerating nozzle; syphoning air into the air syphon hole from atmosphere due to the beverage flowing through the aerating nozzle at velocity; and aerating the beverage within the dispensing passage of the aerating nozzle with the air flow introduced from the air syphon hole.
19. The aeration container of embodiment 18, wherein the aeration container further comprises an aeration plate having a multiplicity of holes formed therethrough positioned within the beverage reservoir spaced apart from and beneath the top wall to delineate an aeration chamber within the beverage reservoir.
20. The aeration container of embodiments 18-19, wherein in the step of tilting the aeration container, air is drawn into the beverage reservoir through an air inlet interacting with the beverage flowing through at least some of the multiplicity of holes issuing in a plurality of beverage streams.

In closing, it is to be understood that, although aspects of the present specification are highlighted by referring to specific embodiments, one skilled in the art will readily appreciate that these disclosed embodiments are only illustrative of the principles of the subject matter disclosed herein. The specific embodiments are not intended to be exhaustive or to limit the invention to the precise forms disclosed. Therefore, it should be understood that the disclosed subject matter is in no way limited to a particular compound, composition, article, apparatus, methodology, protocol, and/or reagent, etc., described herein, unless expressly stated as such. In addition, those of ordinary skill in the art will recognize that certain changes, modifications, permutations, alterations, additions, subtractions and sub-combinations thereof can be made in accordance with the teachings herein without departing from the spirit of the present specification. It is therefore intended that the scope of the invention is not to be limited by this detailed description. Furthermore, it is intended that the following appended claims and claims hereafter introduced are interpreted to include all such changes, modifications, permutations, alterations, additions, subtractions and sub-combinations as are within their true spirit and scope.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified, thus fulfilling the written description of all Markush groups used in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. For instance, as mass spectrometry instruments can vary slightly in determining the mass of a given analyte, the term “about” in the context of the mass of an ion or the mass/charge ratio of an ion refers to +/−0.50 atomic mass unit. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as, e.g., “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising”, variations thereof such as, e.g., “comprise” and “comprises”, and equivalent open-ended transitional phrases thereof like “including,” “containing” and “having”, encompass all the expressly recited elements, limitations, steps, integers, and/or features alone or in combination with unrecited subject matter; the named elements, limitations, steps, integers, and/or features are essential, but other unnamed elements, limitations, steps, integers, and/or features may be added and still form a construct within the scope of the claim. Specific embodiments disclosed herein may be further limited in the claims using the closed-ended transitional phrases “consisting of” or “consisting essentially of” (or variations thereof such as, e.g., “consist of”, “consists of”, “consist essentially of”, and “consists essentially of”) in lieu of or as an amendment for “comprising.” When used in the claims, whether as filed or added per amendment, the closed-ended transitional phrase “consisting of” excludes any element, limitation, step, integer, or feature not expressly recited in the claims. The closed-ended transitional phrase “consisting essentially of” limits the scope of a claim to the expressly recited elements, limitations, steps, integers, and/or features and any other elements, limitations, steps, integers, and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps, integers, and/or features specifically recited in the claim, whereas the meaning of the closed-ended transitional phrase “consisting essentially of” is being defined as only including those elements, limitations, steps, integers, and/or features specifically recited in the claim and those elements, limitations, steps, integers, and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such, the embodiments described herein or so claimed with the phrase “comprising” expressly and unambiguously provide description, enablement and support for the phrases “consisting essentially of” and “consisting of.”

All patents, patent publications, and other references cited and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard is or should be construed as an admission that the inventors are not entitled to antedate such disclosure by virtue of prior invention or for any other reason. All statements as to the date or representation as to the contents of these documents are based on the information available to the applicant and do not constitute any admission as to the correctness of the dates or contents of these documents.

Lastly, the terminology used herein is for the purpose of describing particular embodiments only and is not intended to limit the scope of the present invention, which is defined solely by the claims. Accordingly, the present invention is not limited to that precisely as shown and described.

What is claimed is:

1) An aeration container for containing a beverage, comprising:
a beverage reservoir delineated by a sidewall, a bottom wall, and a top wall opposite the bottom wall, the beverage reservoir being configured to hold the beverage therein, the top wall including an air inlet hole;
an aerating nozzle having a dispensing passage formed therethrough with a reduced diameter portion of the dispensing passage, and an air syphon hole formed transverse to the dispensing passage communicating between the reduced diameter portion of the dispensing passage and atmosphere, the aerating nozzle extending from the top wall such that the dispensing passage provides fluid communication between the beverage reservoir and atmosphere through the dispensing passage; and
an aeration plate having a multiplicity of holes formed therethrough and being positioned within the beverage reservoir spaced apart from and beneath the top wall to delineate an aeration chamber within the beverage reservoir;
wherein, when tilted for dispensing, air is drawn into the beverage reservoir through the air inlet hole of the top plate to interact with the beverage flowing through at least some of the multiplicity of holes issuing in a plurality of beverage streams;
and wherein, when tilted for dispensing, air is drawn into the dispensing passage through the air syphon hole to interact with the beverage flowing through the dispensing passage.

2) The aeration container of claim 1 wherein the dispensing passage of the aerating nozzle further comprises a converging inlet upstream of the reduced diameter portion.

3) The aeration container of claim 2 wherein the dispensing passage of the aerating nozzle further comprises a diverging outlet downstream of the reduced diameter portion.

4) The aeration container of claim 1 further comprising a container lid configured to cover the top wall and substantially enclose the aerating nozzle, the container lid having a pour through opening configured to be aligned with the aerating nozzle such that the beverage issuing from the dispensing passage flows through the pour through opening.

5) The aeration container of claim 4 wherein the pour through opening is sufficiently large to permit simultaneous outflow of the beverage and inflow of the air traveling to the air inlet hole and the air syphon hole.

6) The aeration container of claim 4 wherein the aeration plate is spaced apart from the top wall by a spacer ring further delineating and enclosing the aeration chamber, the side wall includes a first thread and the container lid includes a second thread configured to engage the first thread and hold the spacer ring between the top wall and the aeration plate.

7) The aeration container of claim 1 wherein the beverage reservoir, the aerating nozzle, and the aeration plate are nondestructively separable from one another.

8) An aeration container for containing a beverage, comprising:
a beverage reservoir delineated by a sidewall, a bottom wall, and a top wall opposite the bottom wall, the beverage reservoir being configured to hold the beverage therein; and
an aerating nozzle having a dispensing passage formed therethrough with a reduced diameter portion of the dispensing passage, and an air syphon hole formed transverse to the dispensing passage communicating between the reduced diameter portion of the dispensing passage and atmosphere, the aerating nozzle extending from the top wall such that the dispensing passage provides fluid communication between the beverage reservoir and atmosphere through the dispensing passage;
wherein, when tilted for dispensing, air is drawn into the dispensing passage through the air syphon hole to interact with the beverage flowing through the dispensing passage.

9) The aeration container of claim 8 further comprising an aeration plate having a multiplicity of holes formed therethrough and being positioned within the beverage reservoir spaced apart from and beneath the top wall to delineate an aeration chamber within the beverage reservoir.

10) The aeration container of claim 9 wherein, when tilted for dispensing, air interacts with the beverage flowing through at least some of the multiplicity of holes issuing in a plurality of beverage streams within the aeration chamber.

11) The aeration container of claim 9 wherein the top wall further includes an air inlet hole, wherein, when tilted for dispensing, air is drawn into the beverage reservoir through the air inlet hole of the top plate to interact with the beverage flowing through at least some of the multiplicity of holes issuing in a plurality of beverage streams within the aeration chamber.

12) The aeration container of claim 8 wherein the dispensing passage of the aerating nozzle further comprises a converging inlet upstream of the reduced diameter portion.

13) The aeration container of claim 8 wherein the dispensing passage of the aerating nozzle further comprises a diverging outlet downstream of the reduced diameter portion.

14) The aeration container of claim 8 further comprising a container lid configured to cover the top wall and substantially enclose the aerating nozzle, the container lid having a pour through opening configured to be aligned with the aerating nozzle such that the beverage issuing from the dispensing passage flows through the pour through opening.

15) The aeration container of claim 14 wherein the pour through opening is sufficiently large to permit simultaneous outflow of the beverage and inflow of the air traveling to the air inlet hole and the air syphon hole.

16) The aeration container of claim 9 wherein the aeration plate is spaced apart from the top wall by a spacer ring further delineating and enclosing the aeration chamber, the side wall includes a first thread and the container lid includes a second thread configured to engage the first thread and hold the spacer ring between the top wall and the aeration plate.

17) The aeration container of claim 8 wherein the beverage reservoir, the aerating nozzle, and the aeration plate are nondestructively separable from one another.

18) A method of aerating a beverage comprising:
providing an aeration container having a beverage reservoir containing the beverage therewithin, and with an aerating nozzle extending from a top wall of the aeration container, the aerating nozzle having a dispensing passage formed therethrough with a reduced diameter portion of the dispensing passage, and an air syphon hole formed transverse to the dispensing passage communicating between the reduced diameter portion of the dispensing passage and atmosphere, the dispensing passage provides fluid communication between the beverage reservoir and atmosphere through the dispensing passage;
tilting the aeration container such that the beverage issues from the dispensing passage of the aerating nozzle;
syphoning air into the air syphon hole from atmosphere due to the beverage flowing through the aerating nozzle at velocity; and
aerating the beverage within the dispensing passage of the aerating nozzle with the air flow introduced from the air syphon hole.

19) The method of claim 18 wherein the aeration container further comprises an aeration plate having a multiplicity of holes formed therethrough positioned within the beverage reservoir spaced apart from and beneath the top wall to delineate an aeration chamber within the beverage reservoir.

20) The method of claim 18 wherein, in the step of tilting the aeration container, air is drawn into the beverage reservoir through an air inlet interacting with the beverage flowing through at least some of the multiplicity of holes issuing in a plurality of beverage streams.
